(19) United States
(12) Patent Application Publication
(10) Pub. No.: US 2026/0135199 A1
(43) Pub. Date: May 14, 2026

(54) METAL AIR BATTERY TURBINE ANODE DISC DRIVE SYSTEM

(71) Applicant: AlumaPower Corporation, Sarnia (CA)

(72) Inventor: Geoffrey SHEERIN, Sarnia (CA)

(21) Appl. No.: 19/481,605

(22) PCT Filed: Apr. 30, 2024
(86) PCT No.: PCT/IB2024/054197

§ 371 Date: Nov. 5, 2025

(51) Int. Cl. H01M 12/06; F03B 1/00; H01M 50/77

(52) U.S. Cl. CPC H01M 12/06; F03B 1/00; H01M 50/77

(57) ABSTRACT

This disclosure provides a rotary metal air battery system that rotates without using a rotary motor. A metal anode is rotated by impact of a liquid electrolyte on turbine blades disposed on a radial edge of the metal anode.

### CROSS-REFERENCE TO RELATED APPLICATIONS

This application claims priority to, and is a non-provisional of, U.S. Patent Application 63/501,084 (filed May 9, 2023), the entirety of which is incorporated herein by reference.

### BACKGROUND

Metal air batteries provide a high energy density power source that shows promising applications for mobile and stationary distributed power sources. They have the potential to replace the internal combustion engines found in hybrid cars, locomotives, ships and aircraft since the energy density and efficiency of conversion approach those of hydrocarbon fuels.

Metal air batteries suffer from a number of problems that have, to date, excluded them from use in the aforementioned areas. The metal anode is consumed during the discharge of the battery which impacts the performance as the anode changes size. Also, when the batteries are run open circuit or without load they rapidly produce hydrogen gas in the electrolyte that further increases I2R losses and prevents return to full power when connected to a closed electrical circuit again. Once the metal anode is consumed the battery must be dismantled so it can be mechanically recharged with fresh metal anodes. This process is required to be performed in a shop making the turnaround time a barrier to frequent recharge and use of metal air batteries.

A number of attempts have been made to resolve the aforementioned problems. There has been much research into the chemistry of electrolyte additives that can inhibit the production of hydrogen gas during operation and when in open circuit without much success. Some removable electrode designs have been tested that incorporate protection of the edges of the anode from corrosion and gas production with limited success. Other designs have attempted to mount the anode on a moving apparatus to reduce the increase in resistance due to increase in space between the electrode and cathode. These have been shown to be mechanically complicated and limit the ability to load the battery with fresh metal anodes quickly. None of these solutions have been successfully applied in combination, leaving the metal air battery as a one-use item and difficult to use for intermittent power applications.

### SUMMARY

This disclosure provides a rotary metal air battery system that rotates without using a rotary motor. A metal anode is rotated by impact of a liquid electrolyte on turbine blades disposed on a radial edge of the metal anode.

In a first embodiment, a metal air battery is provided. The metal air battery comprising: a chamber for receiving a liquid electrolyte; a disc disposed within the chamber, wherein the disc consists of an oxidizable metal, the disc having a center point; a turbine on a radial edge of the disc, wherein the turbine has a plurality of turbine blades; an electrolyte port for dispensing the liquid electrolyte onto the plurality of turbine blades, thereby causing the disc to rotate about the center point, and a cathode.

In a second embodiment, a metal anode is provided. The metal anode comprising a disc consisting of an oxidizable metal selected from a group consisting of aluminum, zinc and magnesium; and a turbine on a radial edge of the disc, wherein the turbine comprises a plurality of turbine blades.

In a third embodiment, a metal anode is provided. The metal anode comprising a disc consisting of aluminum; and a turbine on a radial edge of the disc, wherein the turbine comprises a plurality of turbine blades.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a cross section view of a metal air battery system.

FIG. 2 is a cross section view of the metal air battery system showing a fluid path of an electrolyte.

FIG. 3 is a cross section view of the metal air battery system showing a fluid path of a water flush.

FIG. 4 is a cross section view of the metal air battery system showing a fluid path of a gas.

FIG. 5A depicts a means for attaching a turbine to a radial edge of a metal anode.

FIG. 5B depicts the embodiment of FIG. 5A in partial cross section to illustrate turbine blades 504a.

FIG. 5C is a cross section end view depicting a flat radial edge of the turbine.

FIG. 5D is a cross section end view depicting screws that frictionally engage the turbine to a metal anode.

FIG. 6A, FIG. 6B and FIG. 6C depict means for attaching the turbine to the metal anode.

FIG. 7A depicts another means for attaching the turbine to the metal anode.

FIG. 7B is a more detailed depiction of the means for attaching of FIG. 7A.

FIG. 7C depicts a means for attaching the turbine to a metal anode using an arcuate radial edge showing the metal anode before consumption.

FIG. 7D depicts the metal anode of FIG. 7C after partial consumption.

FIG. 7E depicts a means for attaching the turbine to a metal anode using an inverted pointed edge showing the metal anode before consumption.

FIG. 7F depicts the metal anode of FIG. 7E after partial consumption.

FIG. 8 depicts another embodiment wherein the turbine and the metal anode are monolithic.

FIG. 9A, FIG. 9B and FIG. 9C depict a floating metal anode in a circular rim.

FIG. 9D is a bisected cross section showing the circular rim in use.

FIG. 10 depicts a bisected top plan view of a metal anode with a turbine.

### DETAILED DESCRIPTION

This disclosure provides a rotary metal air battery system that rotates without using a rotary motor.

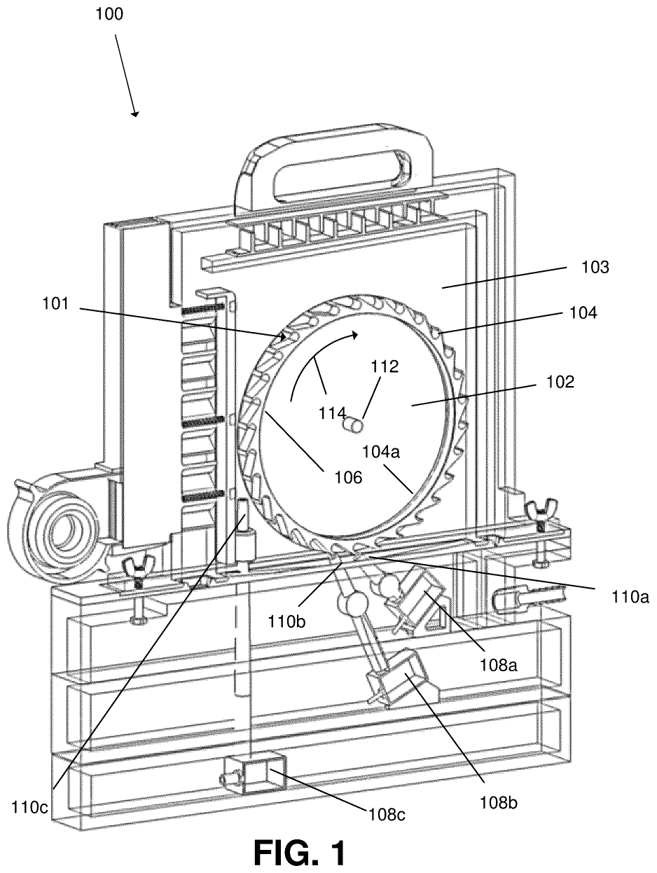

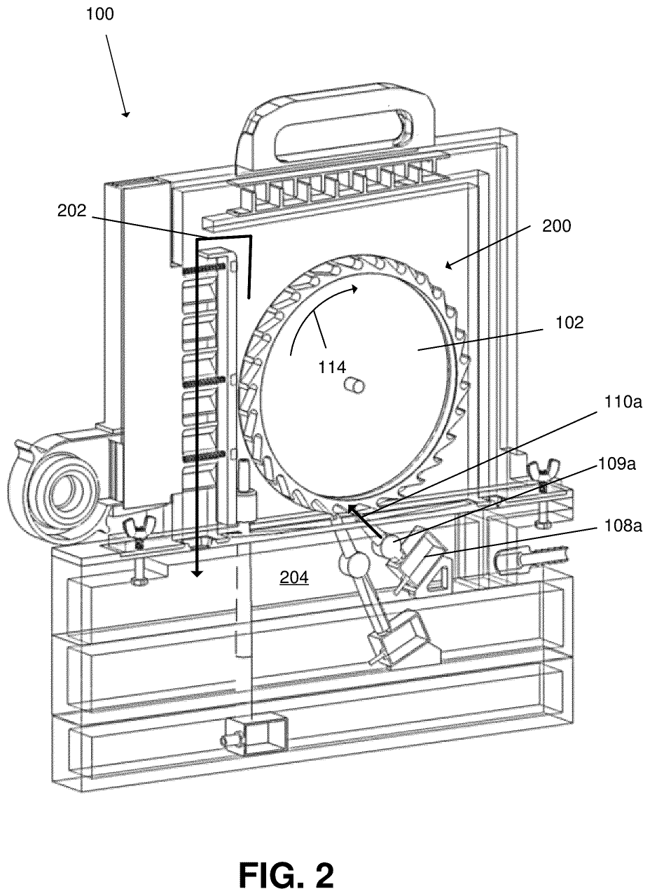

Referring to FIG. 1, a bisected view of a metal air battery system 100 is depicted. The system 100 comprises a disc 101 with a metal anode 102 connected to a turbine 104 on a radial edge 106 of the metal anode 102. A cathode 103 extends parallel to the metal anode 102 and is in the form of a plate. In one embodiment, two cathodes are present on opposing sides of the metal anode 102. At least one fluid pump (e.g. 108a, 108b, 108c) ejects pressurized fluid (e.g. electrolyte, air, electrolyte-free water, etc.) through a respective port (e.g. 110a, 110b, 110c) to provide a jet of fluid which impacts turbine blades 104a. In one embodiment, the velocity of the pressurized fluid is greater than 4.5 meters per second. This causes the metal anode 102 to rotate about a center point 112 in rotary direction 114 without using a rotary motor. In the embodiment of FIG. 1, the ports 110a, 110b, 110c are disposed at a bottom edge of the chamber 200 (see FIG. 2). In other embodiments, the ports may be disposed at other locations provided the resulting pressurized fluid contacts the turbine blades 104a.

The metal anode 102 may be formed from a variety of oxidizable metals including aluminum, zinc, magnesium and iron. In one embodiment, the metal anode 102 comprises the oxidizable metal. In another embodiment, the metal anode 102 consists of the oxidizable metal. The metal anode 102 is in the shape of a disc and may have flat or beveled radial edges.

Referring to FIG. 2, a fluid path of liquid electrolyte is shown. The fluid pump 108a is an electrolyte fluid pump. In use, an electrolyte valve 109a is opened which permits the electrolyte fluid pump 108a to introduce liquid electrolyte through an electrolyte port 110a into a chamber 200 that houses the metal anode 102. In addition to rotating the metal anode 102, the liquid electrolyte fills the chamber 200 until it reaches the overflow port 202 at which time liquid electrolyte returns to an electrolyte compartment 204 for reuse by the electrolyte fluid pump 108a. The overflow port 202 is disposed above the top of the metal anode 102. In this manner, the metal anode 102 is kept submerged under the liquid electrolyte during operation of the metal air batter system 100. In one embodiment, the metal anode 102 rotates at a rate between 25 and 500 rotations per minute (RPM) during operation of the metal air battery system 100. In another embodiment, the metal anode 102 rotates at a rate between 25 and 200 RPM. In yet another embodiment, the metal anode 102 rotates at a rate between 25 and 100 RPM.

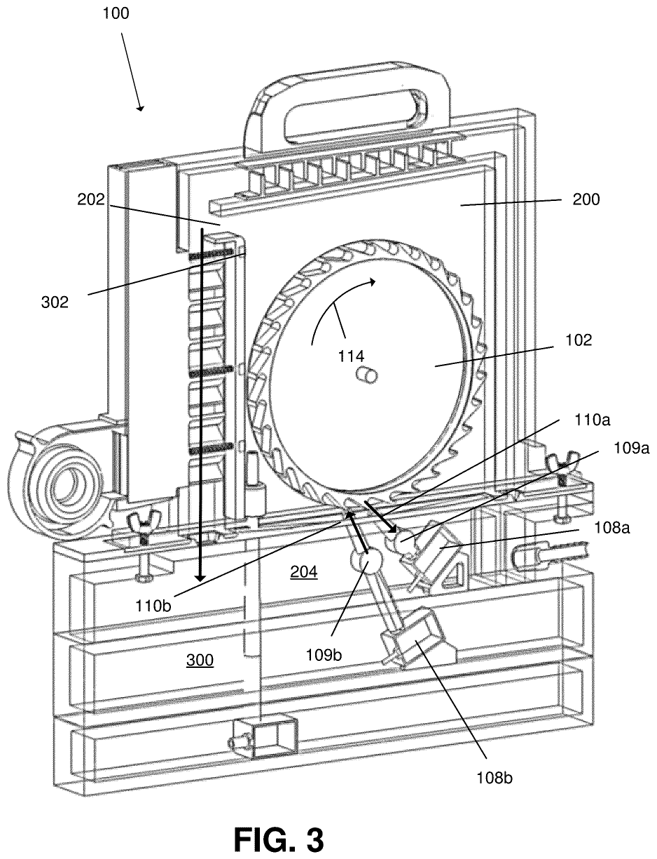

Referring to FIG. 3, a fluid path of a water flush is shown. The fluid pump 108b is a water fluid pump that pumps electrolyte-free water from compartment 300 into the chamber 200 using water port 110b. In use, the metal air battery system is turned off by first deactivating the electrolyte pump 108a while keeping the electrolyte valve 109a open. This permits liquid electrolyte in the chamber 200 to flow back into the electrolyte compartment 204. The residual spinning of the metal anode 102 also provides a spin drying effect to remove residual liquid electrolyte. In the embodiment of FIG. 3 residual electrolyte is drained from the chamber 200 through the electrolyte port 110a. In other embodiments where the electrolyte port 110a is not disposed at the bottom of the chamber 200, a drain hole with a valve may be provided.

After the liquid electrolyte has been drained from the chamber 200, the electrolyte valve 109a is closed and water valve 109b is opened. When the water fluid pump 108b is actuated, electrolyte-free water is injected into the chamber 200 through the water port 110b, thereby contacting the turbine blades 104a, which causes the metal anode 102 to rotate. Such a configuration is useful for high RPM (e.g., over 1000 RPM) washing of the metal anode 102. The electrolyte-free water is introduced into the chamber 200 until a sensor 302 detects the water level. The water level is maintained below the overflow port 202. This permits the metal anode 102 to be maintained under water for long term storage.

Additionally, during operation of the metal air battery system 100 water is slowly consumed. Selective actuation of the water valve 109b allows for the introduction of water into the chamber 200. This selective actuation occurs while the electrolyte pump 108a is active such that the water that was consumed may be replaced.

As used in this specification, the term “electrolyte-free” refers to a liquid that is substantially free of electrolytes such that it has a conductivity below 10,000 μS per cm. In another embodiment, the conductivity is below 5,000 μS per cm. In yet another embodiment, the conductivity is below 1,000 μS per cm.

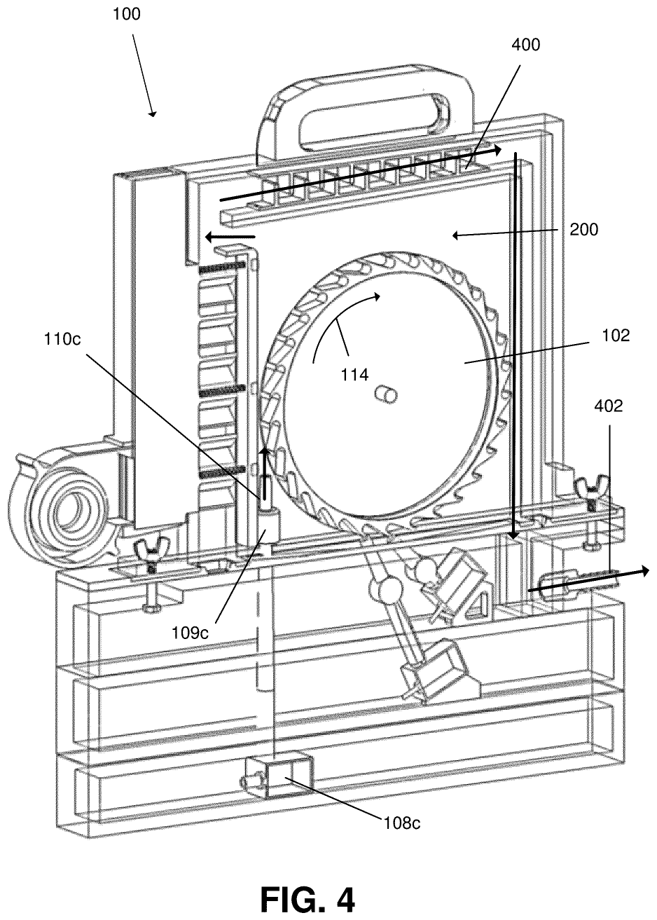

Referring to FIG. 4, a fluid path of gas is shown. The fluid pump 108c is a gas fluid pump that introduces an inert gas (e.g. air, nitrogen) into the chamber 200 using gas port 110c and a gas valve 109c. The inert gas contacts the turbine blades 104a and thereby rotates the metal anode 102 at rate of 1000 RPM or more such that the metal anode is rapidly spun dry of the liquid electrolyte and is used for rapid shutdown. For larger metal anodes, rotation at speeds of over 2000 RPM may be used. For example, the gas fluid pump 108c can provide gas with a pressure of about 8 kPa and a velocity of about 150 meters per second flow rate. In this manner the metal air battery system 100 can be rapidly turned off. The gas escapes the chamber 200 by first passing through a mist eliminator 400 until it exits a gas outlet 402. Hydrogen that is generated during operation of the metal air battery system 100 also passes through the mist eliminator 400 and exits the gas outlet 402.

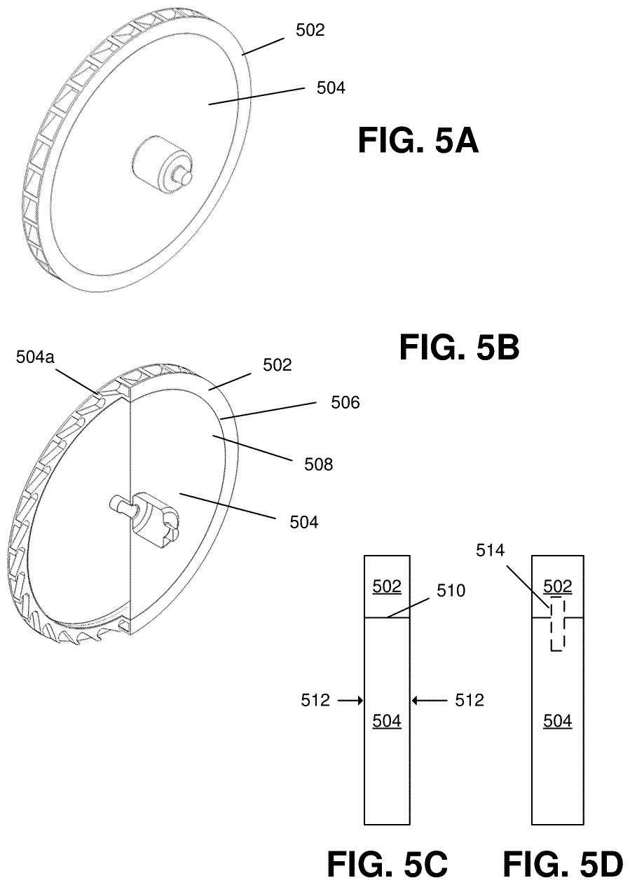

The turbine 104 may be connected to the radial edge 106 of the metal anode 102 using a variety of means for attaching. FIG. 5A and FIG. 5B depict one such means for attaching wherein a turbine 502 is mechanically attached to a metal anode 504 along their respective flat, radial edges. The turbine 502 comprises turbine blades 504a. In one embodiment, the turbine 502 has a circular inner radial edge 506 that is slightly smaller than a circular outer radial edge 508 of the metal anode 504. In this manner the turbine 502 is snapped onto the metal anode 504 such that the two radial edges frictionally engage at their respective flat, radial edges 510 (FIG. 5C). As used in this specification, the phrase “flat radial edge” refers to a radial edge with a flat cross section as shown FIG. 5C.

As shown in FIG. 5C, the liquid electrolyte can contact both exposed surfaces 512 of the metal anode 504. In some embodiments, the frictional engagement is further enhanced by adhesives and/or screws 514 (FIG. 5D). The turbine 502 may be formed from a variety of suitable materials and generally resists oxidation. Suitable materials generally are tolerant of concentrated base (e.g. 8M NaOH) over the life of the air metal battery system 100 and include plastics, brass and stainless steel.

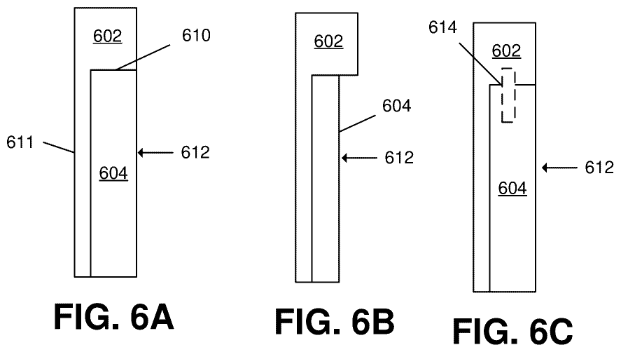

FIG. 6A, FIG. 6B and FIG. 6C depict another means for attaching, wherein a turbine 602 is mechanically attached to a metal anode 604 along their shared flat, radial edges 610. In FIG. 6A and FIG. 6B, the turbine 602 further includes a back plate 611 that covers a back surface of the metal anode 604 such that the metal anode 604 has only a single exposed surface 612. The back surface of the metal anode is perpendicular to the radial edges 610 such that the back surface and the back plate 611 are parallel. Advantageously, the metal anode 604 remains securely attached to the turbine 602 even after the metal anode 604 has been significantly consumed (FIG. 6B). In some embodiments, the frictional engagement is further enhanced by adhesives and/or screws 614 (FIG. 6C).

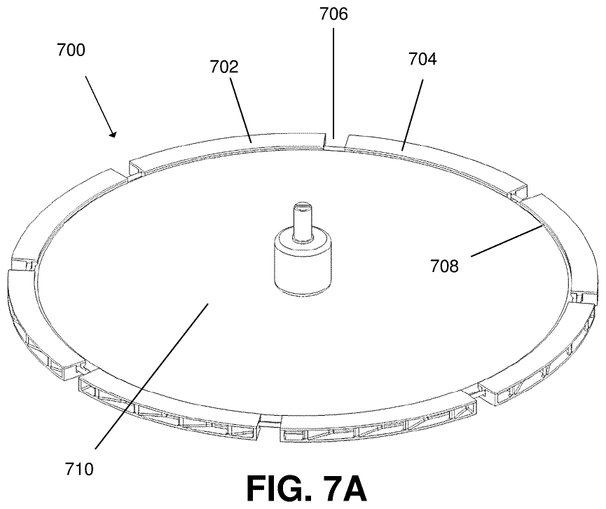

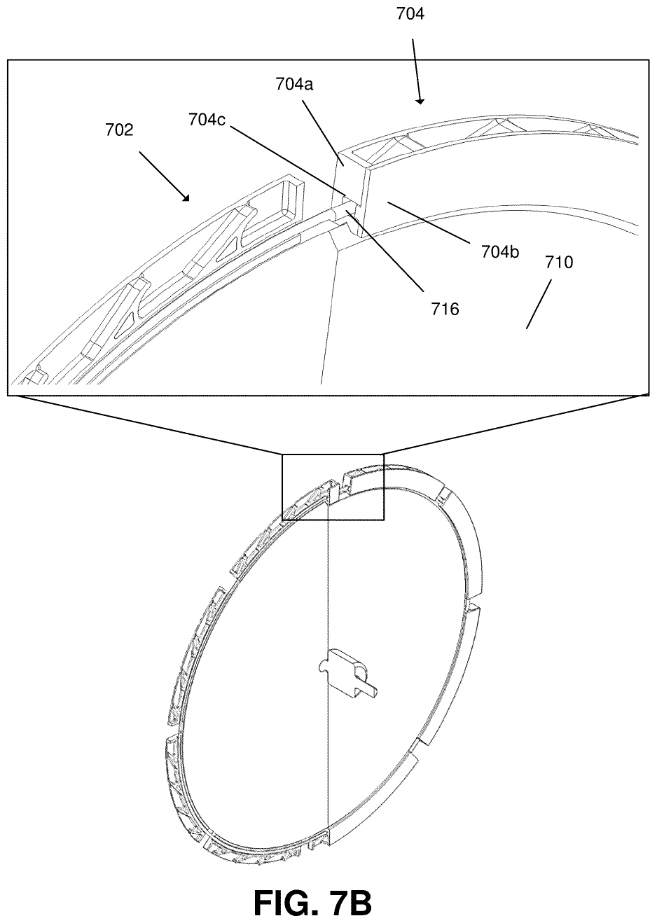

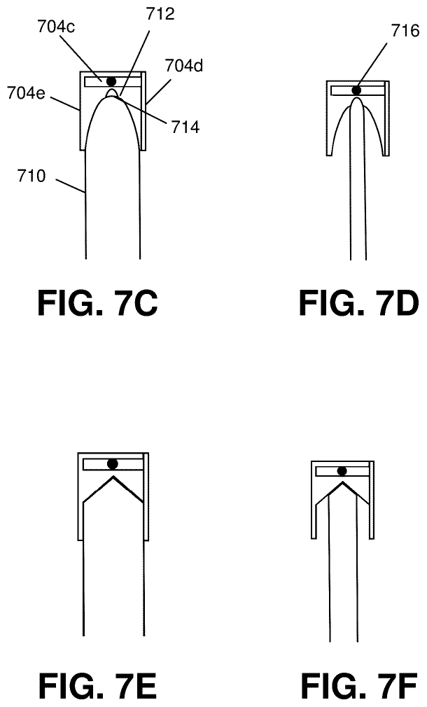

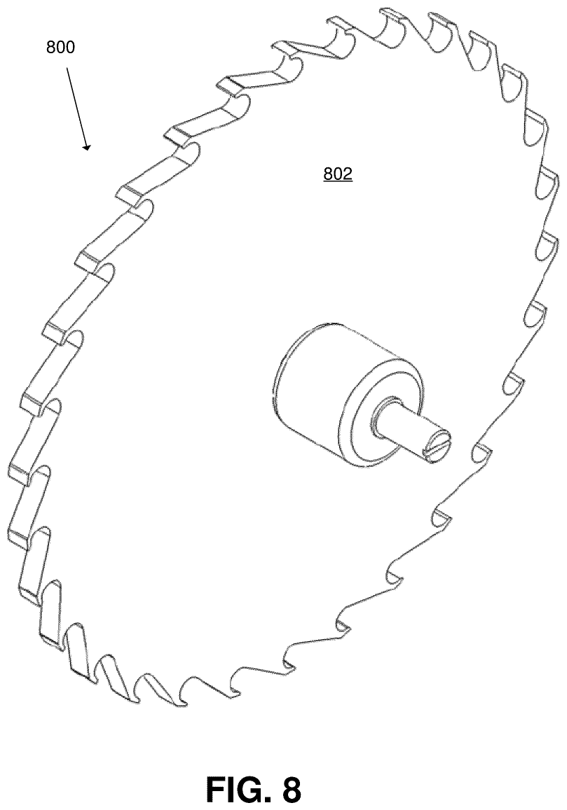

FIG. 7A depicts another means for attaching, wherein the turbine 700 comprises a plurality of arcuate segments 702, 704 separated by gaps 706. Collectively, the plurality of arcuate segments and the gaps circumscribe the radial edge 708 of the metal anode 710. The gaps 706 are bridged by an elastic member such as springs or an elastic band. In use, the metal anode 710 is slowly consumed and changes diameter. As the diameter changes, the elastic member constricts the gaps and brings the arcuate segments closer, thereby keeping the turbine 700 attached to the metal anode 710.

Referring to FIG. 7B, a more detailed depiction of the turbine 700 of FIG. 7A is shown. Arcuate segment 704 comprises a first plate 704a and a second plate 704b that connect (e.g. a snap-fit connection) to form a cavity 704c for receiving the elastic member 716. The arcuate segment 702 has had its second plate removed for illustrative purposes. The first plate 704a and the second plate 704b may have guide arms 704d, 704e (see FIG. 7C) that directly contact the facial surface of the metal anode 710. As shown in FIG. 7C, the interior radial edge 712 of the turbine 700 that contacts the radial edge 714 of the metal anode 710 is beveled with respect to the first plate 704a and the second plate 704b. Likewise, the radial edge 714 of the metal anode 710 has an inverted beveled radial edge with respect to the surface of the metal anode 710. Such a mated tongue and groove configuration helps maintain the elastic member 716 in a centered position with respect to the metal anode 710 as the metal anode 710 is consumed. See FIG. 7C (before consumption) and FIG. 7D (after consumption has begun). In the embodiment of FIGS. 7C and 7D, the interior radial edge 712 and the radial edge 714 are an arcuate radial edge and an inverted arcuate radial edge, respectively. In the embodiment of FIG. 7E (before consumption) and FIG. 7F, the interior radial edge 712 and the radial edge 714 are a pointed edge and an inverted pointed edge.

FIG. 8 depicts another embodiment wherein the turbine 800 and the metal anode 802 are monolithic. In one such embodiment, the turbine 800 and the metal anode 802 are both monolithically formed from the same oxidizable metal. While the blades of the turbine 800 are consumed during operation of the air metal battery, they maintain their shape and continue to provide rotary motion.

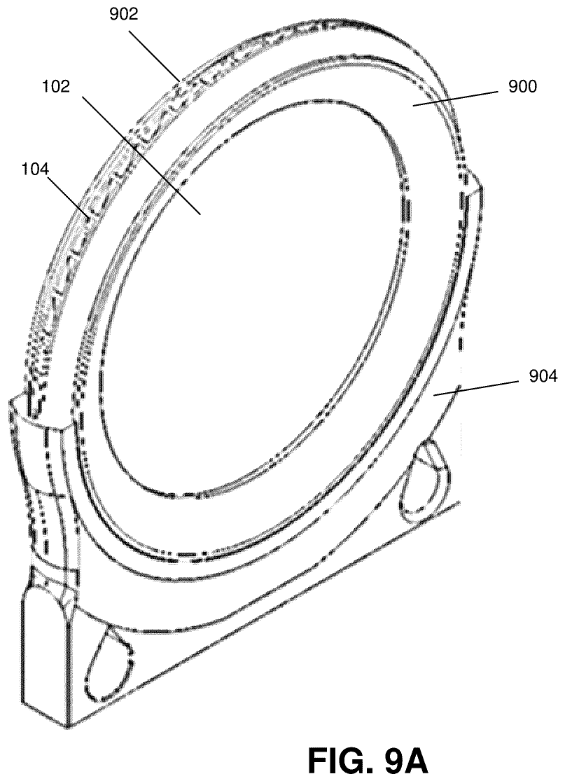

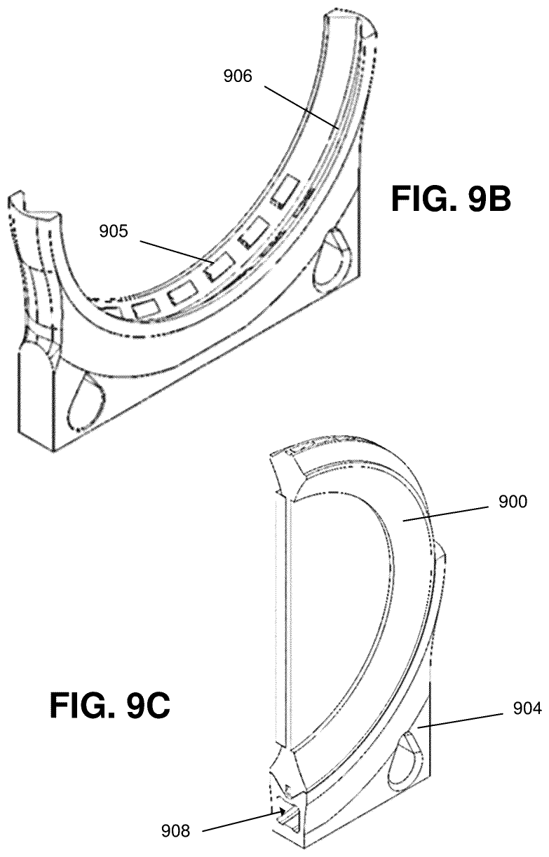

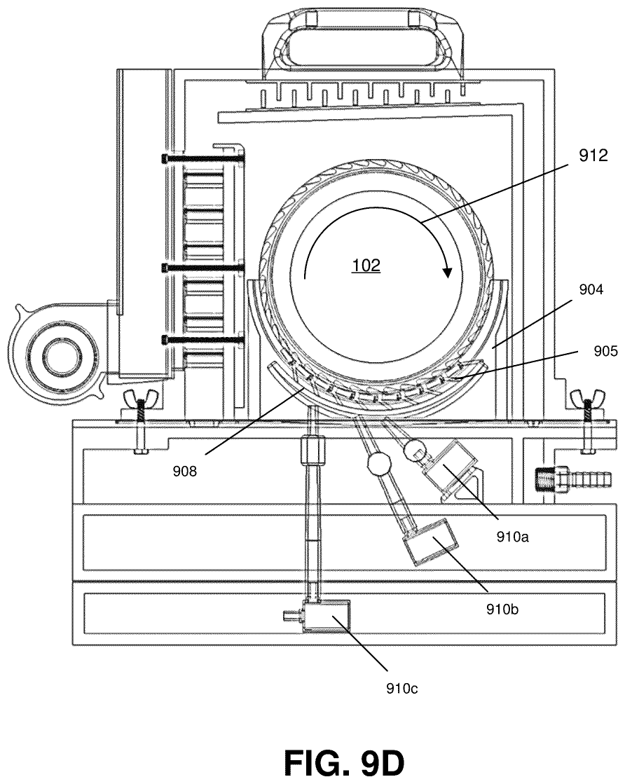

Referring to FIGS. 9A to 9C, a floating metal anode is also contemplated. FIG. 9A depicts the metal anode 102 inserted into a circular rim 900. The combined circular rim 900 and metal anode 102 is relatively buoyant when in the liquid electrolyte (e.g. a density within 5% of the density of the liquid electrolyte). The circular rim includes a plurality of radial ports 902 on its radial edge that align with the turbine blades 104 of the metal anode 102. The facial surfaces of the metal anode 102 remain exposed. The circular rim 900 rests within a base 904 that provides a track 906 (see FIG. 9B) for receiving the circular rim 900. FIG. 9B shows the base 904 without the circular rim 900. The track 906 includes a plurality of ports 905 for providing a fluid from a corresponding pump (not shown) to the turbine blades. FIG. 9C shows a perspective cross section view of the circular rim 900 resting in the base 904.

FIG. 9D is a bisected cross section showing the circular rim 900 in use. The circular rim 900 has been omitted for clarity of illustration. One or more fluid pumps 910a, 910b, 910c selectively provide a fluid (e.g. electrolyte, air, electrolyte-free water, etc.) with corresponding valves and ports. The fluid passes through semicircular plenum 908 (see FIG. 9C) and exits through ports 905 (see FIG. 9B). The ports 905 permit the fluid to impart the same rotational motion to the turbine blades 104 (see FIG. 9A) and thus rotate the metal anode 102 in rotary direction 912. Due to the buoyant nature of the combined metal anode 102 and circular rim 900, as well as the hydrostatic and hydrodynamic forces present, the circular rim 900 floats just above the track 906 when rotating. In the embodiment of FIG. 9D, the ports 905 are angled to deliver the fluid at an oblique angle to the turbine blades 104.

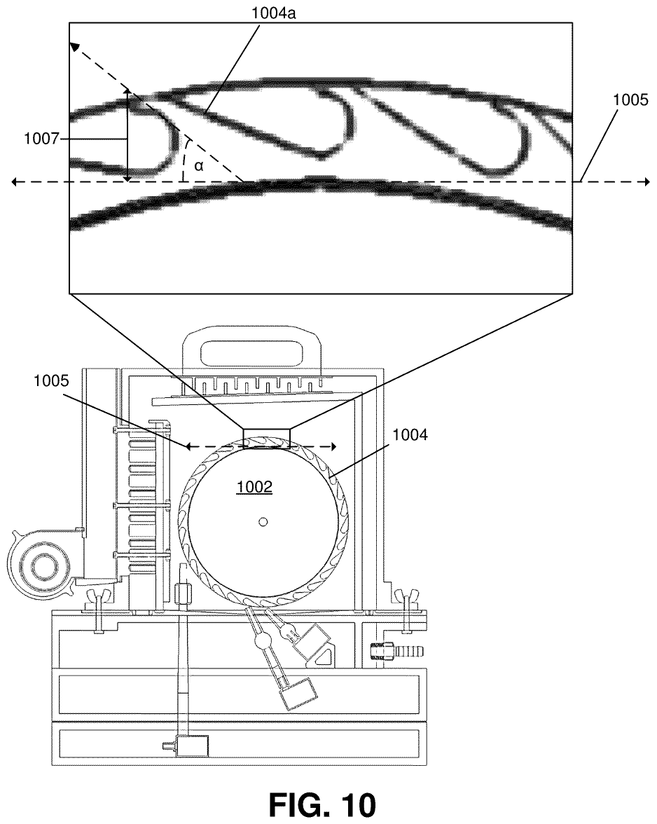

FIG. 10 depicts a top plan view of a metal anode 1002 with a turbine 1004 having turbine blades 1004a. Each turbine blade 1004a is offset from a tangent line 1005 by an angle (α). The angle (α) is an acute angle. The acute angle (α) may be at least 10°, at least 20°, at least 30° or at least 40°. The turbine blades 1004 a extend from the radial edge by a blade height 1007. In one embodiment, there are between 10 and 100 turbine blades on the radial edge. In another embodiment there are between 20 and 60 turbine blades on the radial edge. In one embodiment, the turbine blades are Pelton blades.

A variety of means for withdrawing electricity from the air metal battery system and known in the art and are contemplated for use with this system. Examples include brush conductors, slip ring conductors attached to a framework of the system or contacting the metal anode. Other such mechanisms would be apparent to those skilled in the art after benefitting from reading this disclosure.

While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. A metal air battery comprising:
a chamber for receiving a liquid electrolyte;
a disc disposed within the chamber, wherein the disc consists of an oxidizable metal, the disc having a center point;
a turbine on a radial edge of the disc, wherein the turbine has a plurality of turbine blades;
an electrolyte port for dispensing the liquid electrolyte onto the plurality of turbine blades, thereby causing the disc to rotate about the center point, and a cathode.

2. The metal air battery as recited in claim 1, wherein the oxidizable metal is selected from a group consisting of aluminum, zinc, magnesium and iron.

3. The metal air battery as recited in claim 1, further comprising a water port for dispensing electrolyte-free water into the chamber.

4. The metal air battery as recited in claim 3, wherein the electrolyte-free water is dispensed onto the plurality of turbine blades, thereby causing the disc to rotate about the center point.

5. The metal air battery as recited in claim 1, further comprising a gas port for dispensing a gas into the chamber.

6. The metal air battery as recited in claim 5, wherein the gas is dispensed onto the plurality of turbine blades, thereby causing the disc to rotate about the center point.

7. The metal air battery as recited in claim 1, further comprising a means for attaching the radial edge of the disc to an inner radial edge of the turbine.

8. The metal air battery as recited in claim 1, wherein the radial edge of the disc has a flat cross section, the turbine comprises an inner radial edge with a flat cross section, the radial edge of the disc and the inner radial edge of the turbine being in direct contact.

9. The metal air battery as recited in claim 1, wherein the disc is monolithic and consists of the turbine and the oxidizable metal.

10. The metal air battery as recited in claim 1, wherein the radial edge of the disc has a beveled cross section, the turbine comprises an inner radial edge with a corresponding inverted beveled cross section.

11. The metal air battery as recited in claim 1, wherein the radial edge of the disc has an arcuate cross section, the turbine comprises an inner radial edge with a corresponding inverted arcuate cross section.

12. The metal air battery as recited in claim 1, wherein the radial edge of the disc has a pointed cross section, the turbine comprises an inner radial edge with a corresponding inverted pointed cross section.

13. The metal air battery as recited in claim 1, wherein the turbine further comprises a back plate and a surface of the disc directly contacts the backplate.

14. The metal air battery as recited in claim 1, further comprising
a circular rim that has a plurality of radial ports;
a base with a track for receiving the circular rim;
wherein the disc is fixedly mounted to the circular rim such that the radial ports align with the plurality of turbine blades, the track having at least one port for providing the liquid electrolyte to the plurality of turbine blades.

15. The metal air battery as recited in claim 1, wherein the disc consists of the oxidizable metal and the turbine.

16. A metal anode comprising:
a disc consisting of an oxidizable metal selected from a group consisting of aluminum, zinc and magnesium; and
a turbine on a radial edge of the disc, wherein the turbine comprises a plurality of turbine blades.

17. The metal anode as recited in claim 16, wherein the disc is monolithic and consists of the turbine and the oxidizable metal.

18. The metal anode as recited in claim 16, wherein the radial edge of the disc has a flat cross section, the turbine comprises an inner radial edge with a flat cross section, the radial edge of the disc and the inner radial edge of the turbine being in direct contact.

19. A metal anode comprising:
a disc consisting of aluminum; and
a turbine on a radial edge of the disc, wherein the turbine comprises a plurality of turbine blades.

20. The metal anode as recited in claim 19, wherein the disc and the turbine are monolithic.
